(19) United States
(12) Patent Application Publication
(10) Pub. No.: US 2006/0256305 A1
(43) Pub. Date: Nov. 16, 2006

(54) Exposure apparatus and method for reducing thermal deformity of reticles

(75) Inventor: Yoo-Keun Won, Hwaseong-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/431,085

(22) Filed: May 10, 2006

(30) Foreign Application Priority Data
May 10, 2005 (KR) 10-2005-0038997

(51) Int. Cl. G03B 27/52

(52) U.S. Cl. 355/30; 355/53; 355/75

(57) ABSTRACT

Disclosed is an exposure apparatus and method thereof able to prevent thermal deformity of reticles. The exposure apparatus may includes a reticle container including a plurality of reticles and a reticle stage on which an exposing process is carried. A method for exposing a substrate may include transferring a first reticle to a reticle container having a plurality of slots and transferring the first reticle from one of the plurality of slots to a reticle stage, and controlling temperature of one of the plurality of slots to be set to the saturation temperature of the first reticle.

### PRIORITY CLAIM

A claim of priority is made under 35 U.S.C. § 119 to Korean Patent Application 2005-38997 filed on May 10, 2005, the entire contents of which are hereby incorporated by reference.

### FIELD OF THE INVENTION

Example embodiments of the present invention relate to semiconductor manufacturing equipment. More particularly, example embodiments of the present invention relate to an exposure apparatus and a method of preventing thermal deformity of reticles.

### BACKGROUND

With higher integration of semiconductor devices, problems during manufacturing process, for example, a photo-exposing process, may occur, form example, deformation of lenses or deformity of reticles due to heating. Thermal deformation to the lenses during photo-exposing process may be cured by using photo-exposing equipment with compensation algorithms. However, solutions to compensate for thermal deformity of reticles due to temperature differences between a process chamber and photo-exposing equipment have not been proposed. Although an exposure process may be carried out using an algorithm to compensate for possible defects caused by a heated lens, process uniformity is still insufficient.

To overcome the aforementioned problems, the conventional art discloses a method of minimizing thermal deformity of reticles by equalizing temperatures between a reticle case and a reticle stage in photo-exposing equipment. The reticle case may include a temperature controlling device. Another method of preventing thermal deformity of reticles may include a temperature sensor on a reticle stage to detect temperatures of a process chamber and a reticle. A photo-exposing process may be carried-out when the temperatures of the process chamber and the reticle are the same.

According to the conventional art, product yields and productivity may be improved by decreasing deformity of reticles due to a temperature difference between a process chamber and an apparatus enclosed therein. However, in practice, reticles may always be exposed to a quantity of heat from a light source and thereby deformed by thermal activation. Typically, the intensity of heat applied to a reticle by a light source may be higher than that applied to a lens.

Non-uniform results may occur due to reticle deformity even though exposing processes are carried out under the same conditions, which may be illustrated in FIGS. 1 and 2. FIGS. 1 and 2 are graphic diagrams illustrating a degree of thermal deformity in reticles after an exposing process by photo-exposing equipment of the conventional art, in which a horizontal axis represents serial numbers of substrates (e.g., from #1 to #25) and a vertical axis represents rate of reticle deformity in units of parts per million (ppm). The deformation rates along X and Y axes illustrated in FIG. 1 are different from those illustrated in FIG. 2. This difference may be caused by the fact that a reticle, which may be stored in a reticle case under a first temperature (e.g., 22° C.) is transferred to a reticle stage that may be under a second temperature (e.g., 25° C.) during an exposing process.

### SUMMARY OF THE INVENTION

Example embodiments of the invention may be directed to a method of conducting an exposing process to reduce thermal deformity of reticles by way of temperature control.

An exposure apparatus and method thereof according to example embodiments of the present invention may control temperature of a reticle therein, reducing or preventing thermal deformity of the reticle due to heating of the reticle, and temperature gap between fabrication line and apparatus.

In an example embodiment of the present invention, an exposure apparatus may include a reticle container including a plurality of slots, each of the plurality of slots configured to store a reticle and to individually measure and control a temperature therein, and a reticle stage configured to transcribe a pattern of the reticle onto a substrate.

In another example embodiment of the present invention, an exposure apparatus may include a reticle library including a plurality of slots, each of the plurality of slots configured to store a reticle and to measure and control a temperature therein, a reticle stage including an exposing-light source configured to emit light to transcribe a pattern of the reticle onto a substrate during an exposing process, and a first a sensor configured to measure temperature of the reticle during the exposing process, and a temperature controller configured to control temperature of each of the plurality of slots independently from one another.

Also in another example embodiment of the present invention, a method for exposing a substrate may include transferring a first reticle to a reticle container having a plurality of slots, transferring the first reticle from one of the plurality of slots to a reticle stage, conducting an exposing process on the first reticle on the reticle stage, measuring saturation temperature of the first reticle on the reticle stage, and controlling temperature of one of the plurality of slots to be set to the saturation temperature of the first reticle.

### BRIEF DESCRIPTION OF THE DRAWINGS

The accompanying drawings may be included to provide a further understanding of example embodiments of the present invention, and may be incorporated in and constitute a part of this specification. The drawings may illustrate example embodiments of the present invention and, together with the description, may serve to explain the present invention. In the drawings:

FIGS. 1 and 2 are graphic diagrams illustrating a degree of thermal deformity in reticles after an exposing process by an exposure apparatus of the conventional art;

FIG. 3 is a block diagram illustrating an exposure apparatus in accordance with an example embodiment of the present invention;

FIG. 4 is a block diagram illustrating a reticle library included in an exposure apparatus according to an example embodiment of the present invention;

FIG. 5 is a sectional diagram illustrating a reticle library according to an example embodiment of the present invention;

FIG. 6 is a block diagram illustrating a reticle stage included in an exposure apparatus according to an example embodiment of the present invention; and

FIG. 7 is a sectional diagram illustrating a reticle stage according to an example embodiment of the present invention.

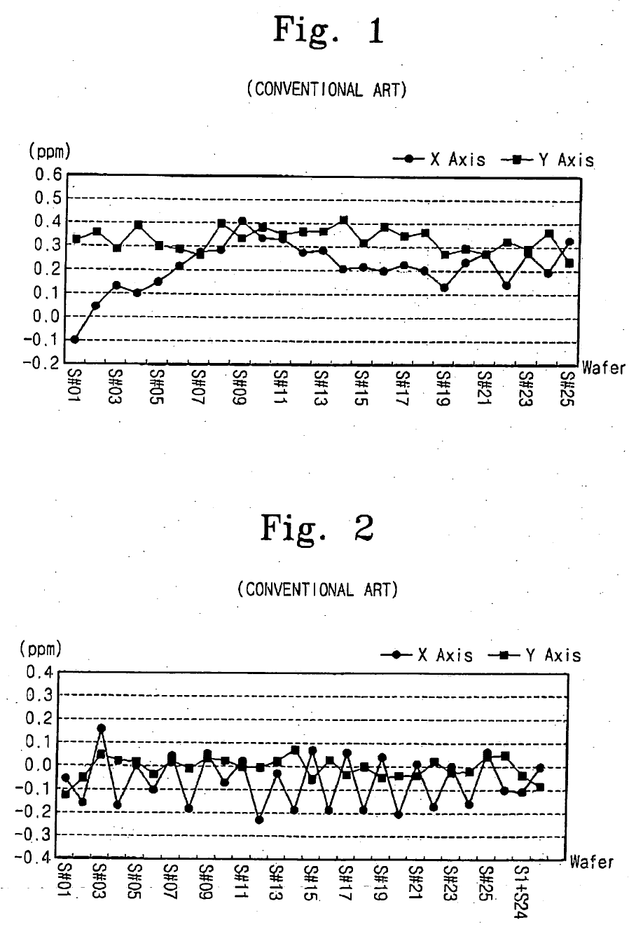

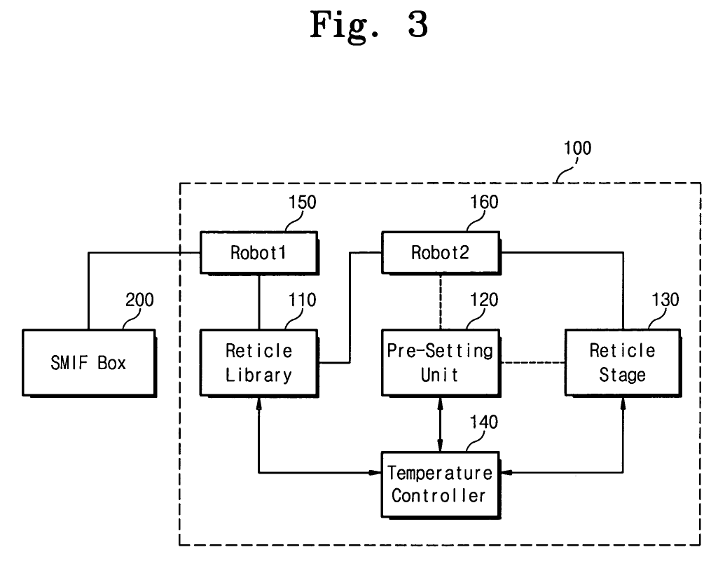

### DETAILED DESCRIPTION OF EXAMPLE EMBODIMENTS OF THE PRESENT INVENTION

Example embodiments of the present invention will be described below in more detail with reference to the accompanying drawings. The present invention may, however, be embodied in different forms and should not be constructed as limited to the example embodiments set forth herein. Rather, these example embodiments are provided as working examples. In the drawings, like numerals refer to like elements throughout the specification.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there may be no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-section illustrations that may be schematic illustrations of idealized embodiments (and intermediate structures) of the present invention. As such, variations from the shapes of the illustrations as a result, for example, of manufacturing techniques and/or tolerances, are to be expected. Thus, the example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 3 is a block diagram illustrating an exposure apparatus in accordance with an example embodiment of the present invention.

Referring to FIG. 3, an exposure apparatus 100 may include a reticle stage 130 on which a reticle may be placed. The reticle may be used to transcribe a specific pattern onto a substrate. A standard mechanical interface (SMIF) box 200 may be used to supply reticles to the reticle stage 130. The exposure apparatus 100 may also include an internal reticle library 110 to provide a place to temporarily hold a reticle prior to being transferred to the reticle stage 130. A reticle may be transferred from the SMIF box 200 to the reticle library 110 by a transfer unit, for example, a first robot ROBOT1 150. The reticle transferred from the reticle library 110 may be transferred to the reticle stage 130 by a second robot ROBOT2 160.

The exposure apparatus 100 may further include a pre-setting unit 120 to vary the temperature of a reticle prior to the reticle being loaded onto the reticle stage 130.

The temperatures of the reticle library 110 and the reticle stage 130 may be controlled by a temperature controller 140. The temperature controller 140 may assure that temperatures of the reticle library 110 and the reticle stage 130, with respect to each other during the transfer of a reticle from the reticle library 110 to the reticle stage 130, are the same or similar to each other. The temperature controller 140 may be connected to both the reticle library 110 and the reticle stage 130 to regulate one or both of their respective temperatures. Alternatively, the temperatures of the reticle library 110 and the reticle stage 130 may be separately regulated by two or more temperature controllers 140, and the two or more temperature controllers 140 may in turn be controlled by a central controller (not shown) that also may control the overall operations of the exposure apparatus 100.

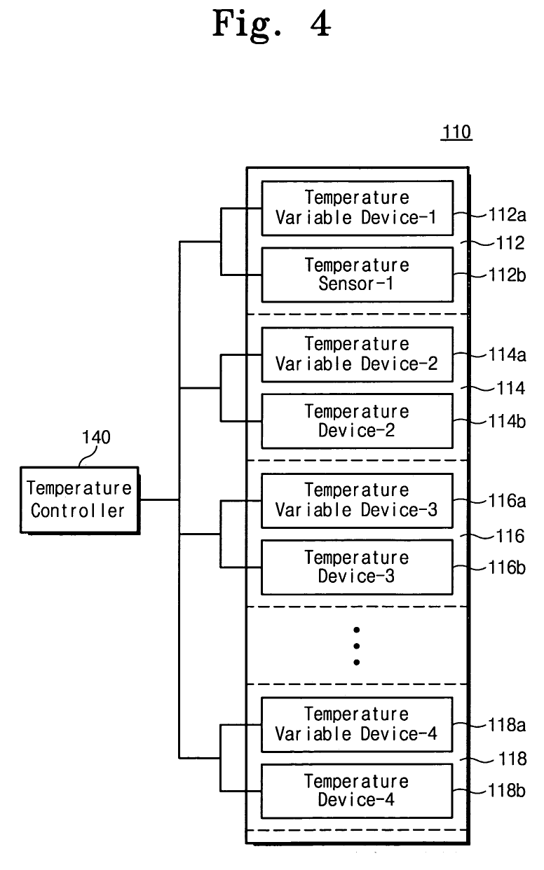

FIG. 4 is a block diagram illustrating a reticle library 110 included in an exposure apparatus according to an example embodiment of the present invention.

Referring to FIG. 4, a reticle library 110 may be included in an exposure apparatus 100 as mentioned above. The reticle library 110 may include slots 112, 114, 116, and 118, each slot configured to hold a reticle. The temperature of each of the slots 112˜118 may be individually controlled and maintained. Each of the slots 112˜118 may include temperature-variable devices 112a˜118a. The slots 112˜118 may further include temperature sensors 112b˜118b to measure temperatures therein. Each of the temperature-variable devices 112a˜118a and the temperature sensors 112b˜118b may be individually set, and may be commonly connected to a temperature controller 140. The temperature-variable devices 112a˜118a may be implemented by a semiconductor device, for example, a thermoelectric semiconductor device that is capable of heating or cooling.

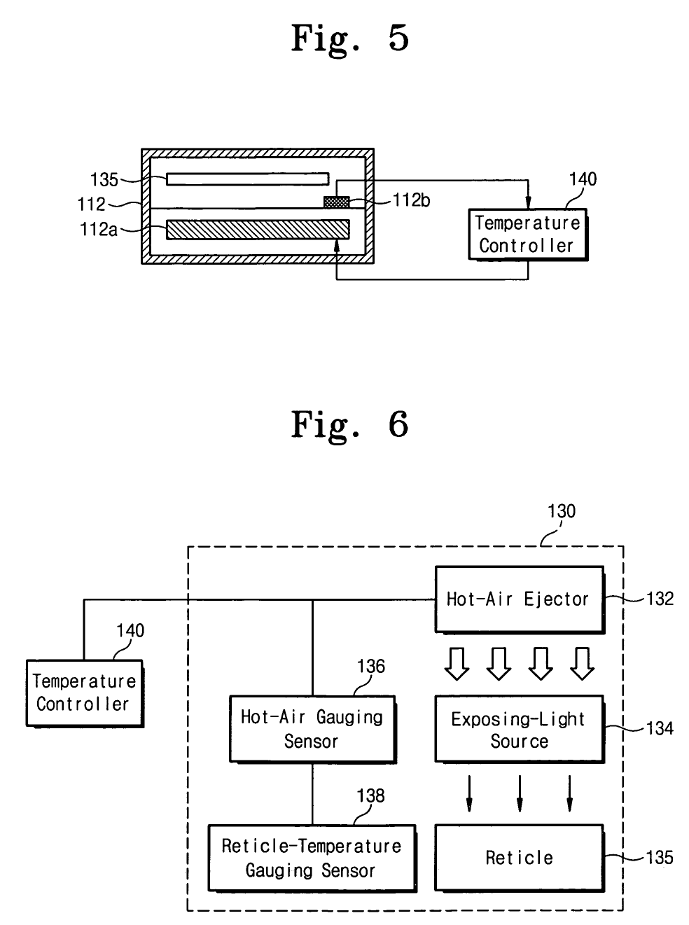

FIG. 5 is a sectional diagram illustrating a structure of a reticle library according to an example embodiment of the present invention.

Referring to FIG. 5, a slot, e.g., 112, of a reticle library 110 may hold a reticle 135 and may include a temperature-variable device 112a made of a thermoelectric semiconductor element that may be capable of raising or lowering the temperature in the slot 112, and a temperature sensor 112b to measure (or detect) the temperature of the slot 112. The temperature-variable device 112a and the temperature sensor 112b may be regulated by the temperature controller 140. If the temperature sensor 112b detects that a measured temperature of the slot 112 is not within a desired temperature range, the temperature-variable device 112a may raise or lower the temperature of the slot 112 accordingly. The structure of the other slots 114˜118 may be the same as that of the slot 112.

FIG. 6 is a block diagram illustrating a reticle stage 130 included in an exposure apparatus according to an example embodiment of the invention.

Referring to FIG. 6, a reticle stage 130, on which a reticle 135 may be placed to transcribe a specific pattern onto a substrate, may include an exposing-light source 134 that may emit light with a desired wavelength to print the pattern of the reticle 135 on the substrate. The reticle 135 may absorb quantities of specific-wavelength light (heat) emitted from the exposing-light source 134 to reach a saturation temperature. The saturation temperature may be defined as a temperature at which a reticle reaches thermal deformation. A temperature sensor 138 may be included in the reticle stage 130. The temperature sensor 138 may measure a real time temperature of the reticle 135 to directly measure a saturation temperature thereof, not an analytical calculation, during an exposing process. The temperature sensor 138 may be configured as a contact or a contactless type. The temperature sensor 138 may measure the temperature of the reticle 135 during an operation of reticle alignment. The reticle stage 130 may also include a fluid (gas or liquid) ejector 132 and a fluid sensor 136. The fluid ejector 132 may eject gas, for example, hot air, to adjust temperature of the reticle stage 130. The fluid sensor 136 may measure flux of the hot air supplied from the fluid ejector 132. The gas may be nitrogen, inert gas, or a mixture thereof. The fluid ejector 132 may be configured to heat or cool the reticle stage 130.

The fluid sensor 136 and the temperature sensor 138 may also be connected to the temperature controller 140. The temperature controller 140 may receive measurement by the fluid sensor 136 and the temperature sensor 138, so that the slots 112˜118 may be maintained at a desired temperature.

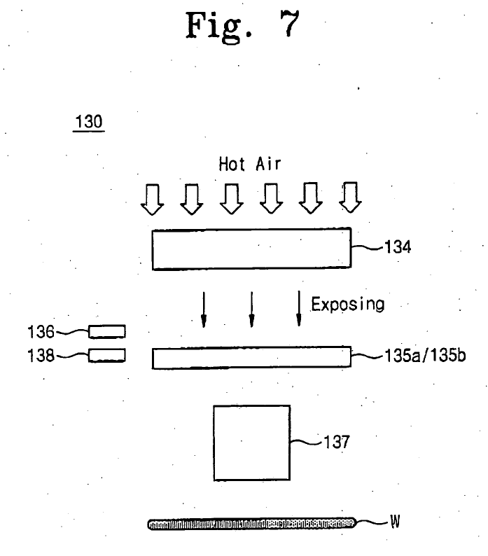

FIG. 7 is a sectional diagram illustrating a reticle stage according to an example embodiment of the present invention.

Referring to FIG. 7, a reticle stage 130 may include an exposing-light source 134, a reticle 135, a lens 137, and a substrate, for example, a wafer W. As aforementioned, the reticle stage 130 may be exposed with fluid from a fluid ejector (not shown). The reticle stage 130 may include a fluid sensor 136 to measure (or gauge) flux of the provided fluid and a temperature sensor 138 to measure temperature of the reticle 135. The fluid sensor 136 may measure flux of the provided fluid to regulate the amount of fluid provided from the fluid ejector 132 and to regulate the temperature of the reticle 135 to a desired temperature.

A pre-setting unit 120, which may have a temperature-varying function as described with respect to FIG. 3, may be connected to a temperature controller 140. Therefore, a temperature of the reticle 135 may be set and/or controlled prior to loading the reticle 135 on the reticle stage 130.

The following Table 1 summarizes an example configuration of an exposure apparatus 100 with reference to processing steps, reticle locations, and temperature-correcting functions.

TABLE 1

| Processing | | |
|---|---|---|
| steps | Reticle locations | Temperature compensation |
| SMIF box | Outside of the | |
| | exposure apparatus | |
| Load robot-1 | Inside of the | |
| | exposure apparatus | |
| Reticle library | | Setting temperature sensor |
| | | per slot, |
| | | Setting and controlling temperature |
| | | per slot |
| Load robot-2 | | |
| Pre-setting unit | | Setting temperature sensor, |
| | | Setting and controlling temperature |
| Reticle stage | | Setting temperature sensor and gas |
| | | flux sensor, Setting and controlling |
| | | temperature |
| Exposure | | Measuring reticle temperature per |
| | | reticle, Compensating temperature |

With reference to FIGS. 3-7, the exposure apparatus 100 configured as aforementioned may operate as follows. A first reticle 135a and a second reticle 135b will be used for clarity and explanation purposes below.

A first reticle 135a may be transferred from a SMIF box 200 to any one of slots 112˜118 of a reticle library 110 in an exposure apparatus 100 by a first robot ROBOT1 150. Because the temperature of each of the slots 112˜118 may be different, the temperature of reticles stored in any one of the slots 112˜118 may be different from each other. The temperature established in any one of the slots 112˜118 may be determined in accordance with a saturation temperature of the reticle 135 stored in the specific slots 112˜118.

The first reticle 135a stored in one of the slots 112˜118 may be transferred to a reticle stage 130 by a second robot ROBOT2 160. The temperature of the first reticle 135a may be directly and continuously monitored to determine the saturation temperature to which the first reticle 135a heats to by thermal conduction during an exposing process. Therefore, for example, the first slot 112, which may hold the first reticle 135a, may be maintained in the saturation temperature of the first reticle 135a. If the first reticle 135a is to be stored in another slot, for example, a second slot 114, then the temperature of the second slot 114 is maintained at the saturation temperature of the first reticle 135a. Each of the slots 112˜118 is maintained at the saturation temperature of the reticle 135 stored therein because the stored reticle 135 may be reused. When the first reticle 135a is placed on the reticle stage 130, there should be no temperature variation between the first reticle 135a and the reticle stage 130, thereby reducing and/or eliminating a thermal deformity of the first reticle 135a.

There may be a difference in the amount of heat transmitted from an exposing-light source 134 to the reticle 135 in accordance with variations of open ratio, material, and exposing dose between one reticle 135 from another reticle 135. In other words, a saturation temperature of the first reticle 135a may be different from that of a second reticle 135b. Therefore, during an exposing process using the second reticle 135b, the second slot 114 may be at the saturation temperature of the second reticle 135b, and the temperature of the reticle stage 130 may also be set at the saturation temperature of the second reticle 135b by regulating flux of fluid ejected from a fluid ejector 132. The temperature of the second slot 114 may be set by a temperature-variable device 114a based on the temperature detected by a temperature sensor 114b. The temperature of the second reticle 135b on the reticle stage 130 may be detected by a temperature sensor 138. If the measured temperature of the reticle stage 130 is not within the saturation temperature of the second reticle 135b, the fluid ejector 132 may adjust the flux of fluid to maintain the reticle stage 130 at the saturation temperature of the second reticle 135b. The flux detection of the gas may be conducted by a fluid sensor 136.

As described above, according to example embodiments of the present invention, a reticle library may be included in an exposure apparatus, which may control the temperature of each reticle, directly measure temperature variations of the reticle on a reticle stage, and regulate the reticle to a saturation temperature. Thus, the example embodiments of the present invention may reduce or prevent thermal deformity of reticles due to temperature gaps, thereby providing uniformity and/or stability during an exposing process.

As described above, according to example embodiments of the present invention, a reticle stage may be included in an exposure apparatus, which may control the temperature of each reticle, directly measure temperature variations of the reticle on a reticle stage, and regulate the reticle to a saturation temperature. Thus, the example embodiments of the present invention may reduce or prevent thermal deformity of reticles due to temperature gaps, thereby providing uniformity and/or stability during an exposing process.

As described above, according to example embodiments of the present invention, an exposure apparatus is provided, which may control the temperature of each reticle, directly measure temperature variations of the reticle on a reticle stage, and regulate the reticle to a saturation temperature as the reticle moves throughout the exposure apparatus, for example, from a reticle library to a reticle stage. Thus, the example embodiments of the present invention may reduce or prevent thermal deformity of reticles due to temperature gaps, thereby providing uniformity and/or stability during an exposing process.

While there have been illustrated and described what may be presently considered to be example embodiments of the present invention, it will be understood by those skilled in the art that various other modifications may be made, and equivalents may be substituted, without departing from the scope of the present invention. Additionally, many modifications may be made to adapt a particular situation to the teachings of the example embodiments of the present invention without departing from the central inventive concept described herein. Therefore, it is intended that the present invention not be limited to the particular example embodiments disclosed, but that the invention may include any and all embodiments falling within the scope of the present invention.

What is claimed is:

1. An exposure apparatus comprising:
a reticle container including a plurality of slots, each of the plurality of slots configured to store a reticle and to individually measure and control a temperature therein; and
a reticle stage configured to transcribe a pattern of the reticle onto a substrate.

2. The exposure apparatus as set forth in claim 1, wherein each of the plurality of slots includes a temperature-variable device configured to heat or cool the slot.

3. The exposure apparatus as set forth in claim 2, wherein the temperature-variable device includes a thermoelectric semiconductor element.

4. The exposure apparatus as set forth in claim 1, wherein each of the plurality of slots includes a sensor configured to detect the temperature therein.

5. The exposure apparatus as set forth in claim 1, wherein the reticle stage includes:
a fluid ejector configured to inject fluid onto the reticle stage;
a first sensor configured to measure a flux of the ejected fluid; and
a second sensor configured to measure the temperature of the reticle.

6. The exposure apparatus as set forth in claim 5, wherein the injected fluid is selected from the group consisting of hot air, hot nitrogen, hot inert gas, and a mixture thereof.

7. The exposure apparatus as set forth in claim 1, further including a temperature controller connected to the reticle container and the reticle stage, and configured to control the temperature of each of the plurality of the slots and the reticle stage.

8. The exposure apparatus as set forth in claim 1, further including:
a first robot configured to transfer the reticle to one of the plurality of slots; and
a second robot configured to transfer the reticle from one of the plurality of slots to the reticle stage.

9. The exposure apparatus as set forth in claim 8, further including a pre-setting unit configured to set the temperature of the reticle prior to the reticle being transferred to the reticle stage.

10. An exposure apparatus comprising:
a reticle library including a plurality of slots, each of the plurality of slots configured to store a reticle and to measure and control a temperature therein;
a reticle stage including an exposing-light source configured to emit light to transcribe a pattern of the reticle onto a substrate during an exposing process, and a first a sensor configured to measure temperature of the reticle during the exposing process; and
a temperature controller configured to control temperature of each of the plurality of slots independently from one another.

11. The exposure apparatus as set forth in claim 10, wherein each of the plurality of slots includes a thermoelectric semiconductor element to heat or cool the slot.

12. The exposure apparatus as set forth in claim 10, wherein each of the plurality of slots includes a second sensor configured to measure temperature therein.

13. The exposure apparatus as set forth in claim 10, further including an ejector configured to eject temperature-varying fluid to maintain the reticle stage to a desired temperature.

14. The exposure apparatus as set forth in claim 13, further including a third sensor configured to measure a flux of the ejected temperature-varying fluid.

15. The exposure apparatus as set forth in claim 13, wherein the temperature-varying fluid is selected from the group consisting of hot air, hot nitrogen, hot inert gas, and a mixture thereof.

16. The exposure apparatus as set forth in claim 13, further including:
a first robot configured to transfer the reticle to one of the plurality of slots; and
a second robot configured to transfer the reticle from one of the plurality of slots to the reticle stage.

17. A method for exposing a substrate, comprising:
transferring a first reticle to a reticle container having a plurality of slots;
transferring the first reticle from one of the plurality of slots to a reticle stage;
conducting an exposing process on the first reticle on the reticle stage;
measuring saturation temperature of the first reticle on the reticle stage; and
controlling a temperature of one of the plurality of slots to be set to the saturation temperature of the first reticle.

18. The method as set forth in claim 17, further including:
transferring a second reticle from one of the plurality of slots to the reticle stage;
conducting an exposing process with the second reticle on the reticle stage;
measuring saturation temperature of the second reticle on the reticle stage; and
controlling the temperature of one of the plurality of slots to be set to the saturation temperature of the second reticle.

19. The method as set forth in one of claims 17, further including:
injecting fluid to control the temperature of the reticle stage to a desired temperature.

20. The method as set forth in claim 19, wherein the ejected fluid is one selected from the group consisting of hot air, hot nitrogen, hot inert gas, and a mixture thereof.
